(19) United States
(12) Patent Application Publication
(10) Pub. No.: US 2017/0251653 A1
(43) Pub. Date: Sep. 7, 2017

(54) Live Bait Container

(71) Applicant: Bait-Store, Inc., Algona, IA (US)

(72) Inventors: Robert Frink, Rock Island, IL (US); Richard Manske, Algona, IA (US)

(73) Assignee: Bait-Store, Inc., Algona, IA (US)

(21) Appl. No.: 15/058,770

(22) Filed: Mar. 2, 2016

(51) Int. Cl. A01K 97/05

(52) U.S. Cl. CPC A01K 97/05

(57) ABSTRACT

A bait container for storing live bait such as minnows. The container has walls with a plurality of small openings adapted to allow water to freely flow between the inside and the outside of the container but not allow the bait to escape from the inside of the container. An opening/lid on one side allows selective access to the inside of the container for retrieving the bait. A shock absorbing system helps to stabilize the container and control the turbulence of rough wave action which helps avoid bruising of the bait inside the container. The shock absorbing system includes at least one tether to secure the container to a dock, boat, or other suitable object. The tether includes an extension spring combined with a shock absorbing member, such as a rope or strap. In some embodiments the shock absorbing system includes two tethers combined with the container at different points.

### BACKGROUND

For as long as the sport of fishing has existed, anglers have used live bait to catch fish. The use of live bait presents a problem to the angler. The angler needs to keep the live bait in a container so that there is easy access. Bait kept in a container, however, is susceptible to injury or death for a variety of reasons. This problem is particularly acute when the live bait is minnows. One reason the minnows tend to die in a live bait container is from lack of oxygen/nutrients due to the container floating near the warmer surface water. Another reason is due to “bruising” of the bait as a result of wave action causing abrupt movements of the container and forcing the bait to hit the inside surface of the container.

Originally, minnow buckets were simply a container that held water and minnows. The container was kept either in the boat or on shore. To extend the life of the minnows the angler would occasionally exchange the old water in the container for fresh water from the lake or stream. This method does not work well since it is difficult to keep the minnows in the bucket while water is being removed from the bucket. Further, minnows would tend to die during the water exchange if the new water was at a temperature significantly different from the old water.

Eventually minnow buckets were developed that floated in the lake or stream. These floating minnow buckets completely encased the minnows inside the buckets. They included holes through the sidewalls that allowed for the free exchange of water inside the container with water outside the container. Sometimes water is exchanged by pouring the water out through the holes and then placing the bucket back in the water to refill. The exchange of water, however, usually occurs when the water outside the container moved relative to the container as the container floats in the water.

The water adjacent to the top surface of a lake or stream tends to be warm. Warm water does not retain oxygen very well and is the primary cause of the death of minnows retained in buckets. In particular, warm water can kill minnows in minutes, while minnows retained in cold water can remain alive for weeks. Water below the top surface tends to be cooler.

There is therefore a need for a live bait container capable of overcoming the deficiencies in the prior art to decrease the mortality rate of live bait.

### SUMMARY

One aspect of the invention relates generally to a bait container for storing live bait such as minnows. The container has walls with a plurality of small openings adapted to allow water to freely flow between the inside and the outside of the container but not allow the bait to escape from the inside of the container. An opening/lid on one side allows selective access to the inside of the container for retrieving the bait. In some embodiments the container is cylindrical with the openings in the curved wall and the lid in one of the planer ends. A shock absorbing system helps to stabilize the container and control the turbulence of rough wave action which helps avoid bruising of the bait inside the container. The shock absorbing system includes at least one tether to secure the container to a dock, boat, or other suitable object. The tether includes an extension spring combined with a shock absorbing member, such as a rope or strap. In some embodiments the shock absorbing system includes two tethers combined with the container at different points. The container may be slightly denser than water (almost neutrally buoyant) so that it remains submerged beneath the surface of the water without exerting significant downward force on the shock absorbing tether system.

Another aspect the invention relates to a method of using a bait container to store live bait such as minnows. After filling the bait container with live bait, the user submerges the container below the surface of the water, preferably near the bottom of the lake (or other body of water) where the water is cooler and contains more nutrients. A shock absorbing system helps to stabilize the container to control the turbulence of rough wave action which helps avoid bruising of the bait inside the container. The shock absorbing system includes a tether comprising a spring combined with a shock absorbing member. One end of the tether is combined with the container and the other end is combined with a dock, boat, or other suitable object. In one embodiment two tethers are used wherein one is combined with the container at a first point and another is combined with the container at another point. The connection points may be at opposite ends so the user can adjust the angle that the container is suspended in the water. When access to the bait is desired, the user can raise the bait container to the surface, open the lid, and retrieve bait from inside the container. After the bait has been retrieved, the lid is closed and the container is returned to its position below the surface of the water.

### BRIEF DESCRIPTION OF THE DRAWINGS

FIG. 1 is a side view of a bait container suspended below the water surface.

FIG. 2 is a perspective view of a bait container.

FIG. 3 is a perspective view of the shock absorbing system.

### DETAILED DESCRIPTION

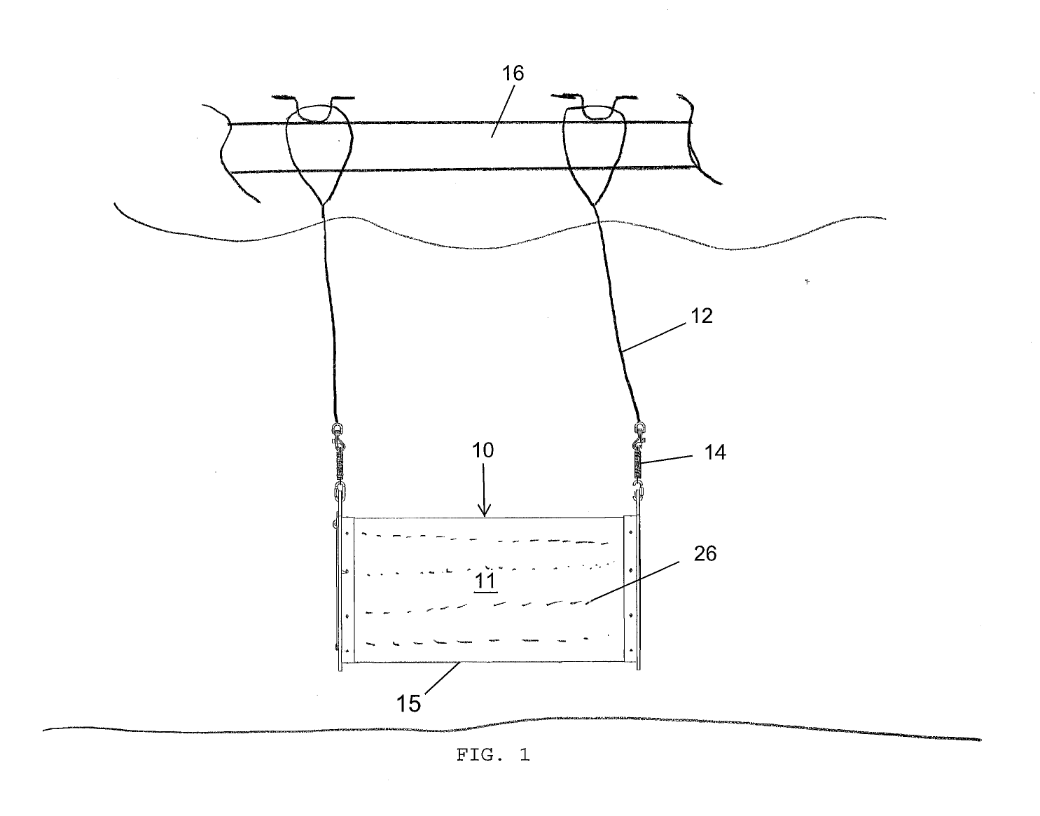

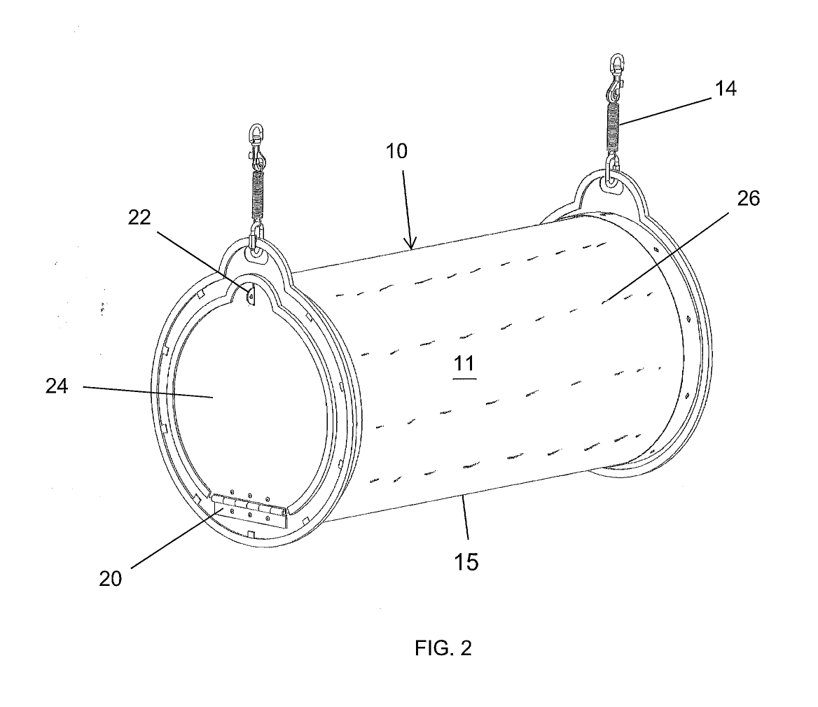

FIGS. 1 and 2 generally depict a bait container 10 for storing live bait such as minnows. The container 10 has a housing with at least one wall having a plurality of small openings 26 adapted to allow water to freely flow between the inside and the outside of the container 10 but not allow bait to escape from the container 10. An opening/lid 24 allows selective access to the inside of the container 10. In some embodiments the container 10 is cylindrical with the openings 26 in the curved side wall 11 and the lid 24 in one of the planer end walls as shown in FIG. 2. In some embodiments the lid 24 is attached to the end wall by a hinge which allows the lid 24 to pivot between an open position and a closed position. A latch 22 such as a cam latch allows the user to selectively secure the lid 24 in its closed position.

In some embodiments the container 10 is slightly denser than water allowing it to sink slowly toward the bottom of the lake (or other body or water). In one embodiment the container 10 sinks in water at between about one-half and four feet per second. In a preferred embodiment the container sinks in water at about one and a half feet per second. Although the container sinks, it is only slightly denser than water so that once submerged, it is generally neutrally buoyant. The curved wall 11 may be made from a polypropylene plastic sheet and the lid 24 from stainless steel to help achieve the proper buoyancy. A seam 15 extends along the bottom longitudinal axis of the curved wall 11. The seam 15 is made from a material that is more dense than polypropylene such as stainless steel. The density of the seam 15 helps keep the container 10 properly oriented in the water with the seam 15 on the bottom and the shock absorbing system (described below) extending upward from the top as shown in FIG. 2. The general neutral buoyancy allows the container 10 to remain submerged beneath the surface of the water without exerting significant downward force on the shock absorbing tether system (described below). This helps prevent the container 10 from bouncing as the container 10 is lowered into the water and also during heavy wave action.

FIGS. 1-3 show the container 10 combined with a shock absorbing system which helps to stabilize the container 10 and control the turbulence of wave action which helps avoid bruising of the bait inside the container 10. The shock absorbing system includes at least one tether for fastening the container 10 to a secure object such as a dock 16, boat, or other suitable object. The tether includes an extension spring 14 combined with a shock absorbing member 12, such as a rope, cord, or strap. The extension spring 14 is preferably a stainless steel shock absorber extension spring 14 having a wire diameter, spring length and tempering which are selected based on the anticipated force of wave action and the weight of the container. In one embodiment each spring has an initial tension of between about three and seven pounds with a preferred initial tension being about five pounds. Each spring has a maximum load (load at full extension) of between about eighteen and thirty pounds with a preferred maximum load being about twenty-two pounds. In one embodiment the initial tension and maximum load are determined based on the weight of the container 10. The initial tension should be less than the total weight of the container 10 so that the spring(s) provide some energy absorbsion when the container 10 hangs in the air. For example, for a container 10 weighing thirteen pounds and a system having two springs 14, each spring 14 could an initial tension of about five pounds so that the total initial tension of the two springs 14 (ten pounds total) would be slightly less than the weight of the container 10. The maximum load of the springs 14 is about three times the weight of the container 10. For example, for a container 10 weighing thirteen pounds and a system having two spring 14, each spring 14 could have a maximum load of about twenty-two pounds (forty four pounds total).

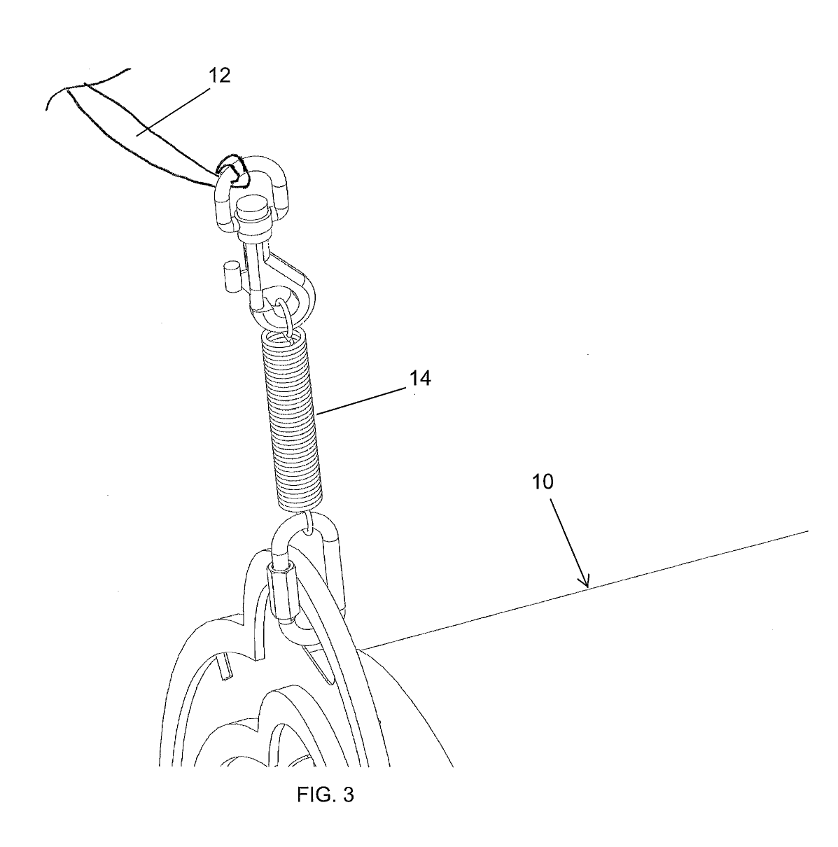

The shock absorbing member 12 is preferably a shock absorbing rope typical of the type of rope used for mooring of water craft. The shock absorbing member 12 may be made from nylon or other suitable material. Preferably, the extension spring 14 is combined with the container 10 and the shock absorbing member 12 is combined with the secure object as shown in FIG. 1, however, the location of the two components 12, 14 may be reversed. As shown in FIG. 3, fasteners such as bolt snaps, swivel joint, trigger snaps, and carabineers may be used to combine one end of the spring 14 to connection points on the container 10 and the other end of the spring 14 to the shock absorbing member 12. The use of a fastener capable of pivoting or rotating (such as a bolt snap or swivel joint) is beneficial because it dampens any twisting motion applied to the container 10 or the absorbing member 12. The shock absorbing system helps to control sudden and harsh movement of the bait container 10 which helps to minimize bruising the bait.

The tethers, one at each end of the container 10 as shown in FIG. 1, allow for positioning the container 10 at an adjustable submerged depth and are used to raise and position the container for accessing the bait. In the embodiment shown in FIG. 1, the members 12 are adjusted to counter balance the container 10 in a generally horizontal position in the water column such that the length of the internal volume of the container 10 is greater than its height. Minnows tend to swim horizontally and in a circular path. The horizontal orientation better accommodates their natural swim pattern. However, by shortening one of the shock absorbing members 12 more than the other shock absorbing member 12 the container 10 may be positioned such that one end is higher in the water column thereby angling the container 10 or positing the container 10 in a generally vertical configuration. Positioning the container 10 in a more vertical orientation allows the user easier access to the lid 24 for obtaining bait from within the container 10.

The container 10 is of a specified dimension and is constructed of a perforated plastic material. The specific size and material of construction for the container 10 is calculated to establish values to establish force factors. The calculated surface forces on the container 10 are used to establish the material selections specific to the calculations to provide motion control and determines requirements of the shock absorbing assembly. Large inland fresh water lakes wave action is based on high wave criteria.

Another aspect the invention relates to a method of using a bait container 10 to store live bait such as minnows. After filling the bait container 10 with live bait, the user submerges the container 10 below the surface of the water, preferably between about four to eight feet below the surface of the water. More preferably near the bottom of the lake (or other body of water) where the water is cooler and contains more nutrients. Natural water exchange occurs as water flows in and out of the container 10 through the openings 26. There is little or no turbulence since the submerged container 10 remains generally stationary as the water flows through the openings 26. A shock absorbing system helps to stabilize the container 10 to control the turbulence of rough wave action which helps avoid bruising of the bait inside the container 10. The shock absorbing system includes an extension spring 14 combined with a shock absorbing member 12 such as a rope. One end of the shock absorbing system is combined with the container 10 and the other end is combined with a dock, boat, or other suitable object. In one embodiment two shock absorbing systems are used wherein one is combined with the container 10 at a first point and another is combined with the container 10 at another point. The connections points may be at opposite ends of the container 10 so the user can adjust the angle that the container 10 is suspended in the water. When access to the bait is desired, the user can raise the bait container 10 to the surface, open the lid, and retrieve bait from inside the container 10. After the bait has been retrieved, the lid is closed and the container 10 is returned to its position below the surface of the water.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. A bait container comprising:
a housing having a wall which defines an inside of the bait container and an outside of the bait container and a lid movable between an open position and a closed position;
a plurality of openings in the wall adapted to allow water to flow between the inside and the outside;
a first tether combined with a first connection point on the housing, wherein the first tether includes a spring and a shock absorbing member.

2. The bait container of claim 1 wherein the wall is tubular and the housing further comprises a first end on one side and a second end on another side so the housing forms a cylindrical shape.

3. The bait container of claim 1 wherein the housing is denser than water allowing it to sink when placed in water.

4. The bait container of claim 1 wherein the shock absorbing member is a rope.

5. The bait container of claim 1 wherein the spring is an extension spring.

6. The bait container of claim 1 further comprising a second tether combined with a second connection point on the housing, wherein the second tether includes a spring and a shock absorbing member.

7. The bait container of claim 1 wherein the container has a length and a height and the length is greater than the height.

8. The container of claim 1 further comprising a weight and wherein the spring has an initial tension that is less than the weight of the container.

9. The container of claim 1 further comprising a weight and wherein the spring has a maximum load equal to about three times the weight of the container.

10. A bait container comprising:
a housing having a wall which defines an inside of the bait container and an outside of the bait container, a length defined by a first end opposite from a second end, and a height, wherein the length is greater than the height;
a lid in the first end movable between an open position and a closed position;
a plurality of openings in the wall adapted to allow water to flow between the inside and the outside;
a first tether combined with a first connection point on the first end of the housing, wherein the first tether includes a spring and a shock absorbing member;
a second tether combined with a second connection point on the second end of the housing, wherein the second tether includes a spring and a shock absorbing member.

11. The bait container of claim 10 wherein the wall is tubular so that the wall, first end, and second end form a cylindrical shape.

12. The bait container of claim 10 wherein the housing and lid together are denser than water allowing the container to sink when placed in water.

13. The bait container of claim 10 wherein the shock absorbing member is a rope.

14. The bait container of claim 10 wherein the spring is an extension spring.

15. The container of claim 10 further comprising a weight and wherein the spring on the first tether and the spring on the second tether together have an initial tension that is less than the weight of the container.

16. The container of claim 10 further comprising a weight and wherein the spring on the first tether and the spring on the second tether together have a maximum load equal to about three times the weight of the container.

17. A method of using a bait container in a body of water having a water surface and a bottom, said bait container having a length and a height wherein the length is greater than the height, said method comprising:
filling the bait container with live bait;
securing one end of the bait container to a first end of a first tether;
securing another end of the bait container to a first end of a second tether;
wherein the first tether and the second tether each have a second end;
securing the second end of each tether to a secure structure above the water surface;
submerging the bait container into the water so that the bait container is suspended beneath the water surface with its length in a generally horizontal position.

18. The method of claim 17 wherein the bait container is submerged into the water to a depth that is just above the bottom of the body of water.

19. The method of claim 17 further comprising the step of pulling upward on the first tether to raise the bait container to the water surface, retrieving bait from the bait container.

20. The method of claim 17 wherein the first tether and the second tether each comprise a spring and a shock absorbing member.
